(19) United States
(12) Patent Application Publication
(10) Pub. No.: US 2012/0137843 A1
(43) Pub. Date: Jun. 7, 2012

(54) TUBE CUTTING

(76) Inventors: Carina Petersson, Forslov (SE); Sandra Philipsson, Bastad (SE); Niklas Svensson, Bastad (SE); Lars Karlsson, Vejbystrand (SE)

(21) Appl. No.: 13/145,160

(22) PCT Filed: Feb. 25, 2010
(86) PCT No.: PCT/SE2010/050219

§ 371 Date: Sep. 12, 2011

(30) Foreign Application Priority Data
Feb. 27, 2009 (SE) 0900263-5

(51) Int. Cl. B23D 21/14; B23D 21/00

(52) U.S. Cl. 82/54; 82/46

(57) ABSTRACT

A knife holder (402) for a tube cutting unit is adapted to receiving a rotating tube fed out from a tube manufacturing device in a feed direction (316). The feed direction is parallel with the tube's longitudinal direction and the rotation takes place about an axis in the tube's longitudinal direction. The knife holder is adapted to following the rotating tube in the latter's longitudinal direction and to bringing a knife element into contact with the tube in a cutting direction and thereby creating in the rotating tube a cut at right angles to the longitudinal direction of the tube. The knife holder is further provided with at least a first bearing element (414) and a second bearing element (415) configured to engage in respective brackets (416, 417) in the tube cutting unit. The bearing elements are so disposed relative to one another that the perpendicular direction (464) to a plane (462), which plane runs in the cutting direction through the bearing elements, and the longitudinal direction of the tube deviate from being parallel.

### TECHNICAL FIELD

The present invention relates to devices for manufacture of tubes and, in particular, to cutting of tubes with a knife fitted in a knife holder.

### BACKGROUND TO THE INVENTION

American specification U.S. Pat. No. 5,992,275 refers to a tube manufacturing device for manufacture of tubes. The tube manufacturing device is fed with a continuous metal strip which is shaped before it enters the device. The tube manufacturing device is provided with a forming head which imparts a spiral shape to the metal strip. Together with the forming head, the tube manufacturing device comprises an element adapted to putting the edge portions of the strip together to constitute the spirally formed tube. This process and feeding of metal strip to the forming head take place continuously and the feed direction of the tube is parallel with its longitudinal direction.

When the tube has been made to a desired length in the feed direction, it is cut. Cutting is effected by a knife element fitted in a knife holder which is part of a cutting unit in the tube manufacturing device. Cutting involves the knife element being placed against the rotating tube and travelling during the cutting process at the feed rate of the tube and parallel with a centreline of the tube during continuous rotation of the tube. After one revolution of the tube, the knife element will have cut a full turn in the surface of the tube, thereby dividing the tube into two parts.

The fact that the tube rotates against the knife element in a direction and is at the same time pressed against the knife element to cause the knife element to cut through the surface of the tube results in a force against the knife element. This force is transmitted to a shaft which supports the knife element and thence to the knife holder of the knife element. The combination of the force from the rotation of the tube and the pressing force from the tube against the knife element results in a force component against the knife holder. Owing to the rotation of the tube, this force component is asymmetrical and therefore not evenly distributed, subjecting both the shaft and the knife holder to an angled force in the tube manufacturing device. This results in knife holders according to U.S. Pat. No. 5,992,275 being subject to wear because their fastenings with the tube manufacturing device are symmetrically disposed relative to the knife holder and not disposed in the best possible way for absorbing the force component which occurs during cutting of tubes.

### SUMMARY OF THE INVENTION

To overcome the shortcomings discussed above of the state of the art, a first aspect proposed is a knife holder for a tube cutting unit adapted to receiving a rotating tube fed out from a tube manufacturing device in a feed direction. The feed direction is parallel with the tube's longitudinal direction and the rotation takes place about a shaft in the tube's longitudinal direction. The knife holder is so disposed that in the tube's longitudinal direction it follows the rotating tube and that in a cutting direction it brings a knife element into contact with the tube and thereby creates a cut in the rotating tube at right angles to the tube's longitudinal direction. The knife holder is further provided with at least a first bearing element and a second bearing element configured to engage in respective brackets in the tube cutting unit. The bearing elements are so disposed relative to one another that the perpendicular direction to a plane, which plane runs in the cutting direction through the bearing elements, and the tube's longitudinal direction deviate from being parallel.

The positioning of the bearing elements relative to the tube's longitudinal direction and feed direction makes it possible for such a knife holder to absorb the force component which occurs during cutting. An advantage of this is that wear on the knife holder is reduced, with consequent possible reduction of, for example, repair and maintenance costs.

The bearing elements, e.g. in the form of linear elements, may be disposed respectively on a first side and a second side of the knife holder, which second side is not opposite to the first side, and in certain cases the non-opposite sides may be at right angles to one another.

In such configurations, a first side of the knife holder may be parallel with the tube's longitudinal direction and the second side may be at right angles to the tube's longitudinal direction. In addition, the direction of a perpendicular vector from the second side of the knife holder may be parallel with the tube's longitudinal direction and run in or against the feed direction.

Such configurations further enhance the effects achieved as summarised above.

A second aspect proposed is a pipe cutting unit adapted to receiving a rotating tube fed out from a tube manufacturing device which comprises a knife holder as summarised above. Such a tube cutting unit may comprise a back-up, e.g. in the form of a second knife element, so disposed in the tube cutting unit that it is situated on the inside of the tube being received and cooperates with the knife element in the knife holder in such a way that an anvil for the knife element is provided by the back-up.

Further aspects are a system which comprises a tube manufacturing device and such a tube cutting unit, and use of such a system.

These further aspects have effects and advantages corresponding to those summarised above.

### BRIEF DESCRIPTION OF THE DRAWINGS

Embodiments are described below in more detail with reference to the attached drawings, which only depict the parts which are necessary for understanding the invention, and in which:

FIG. 1 depicts a tube manufacturing device with forming head, cutting unit and a continuous metal strip which is fed from a feed device,

FIG. 2 depicts a tube manufacturing device with forming head, cutting unit and tube being made,

FIG. 3 depicts a knife holder for a cutting unit, and

FIG. 4 depicts a knife holder with an imaginary plane.

### DETAILED DESCRIPTION OF EMBODIMENTS

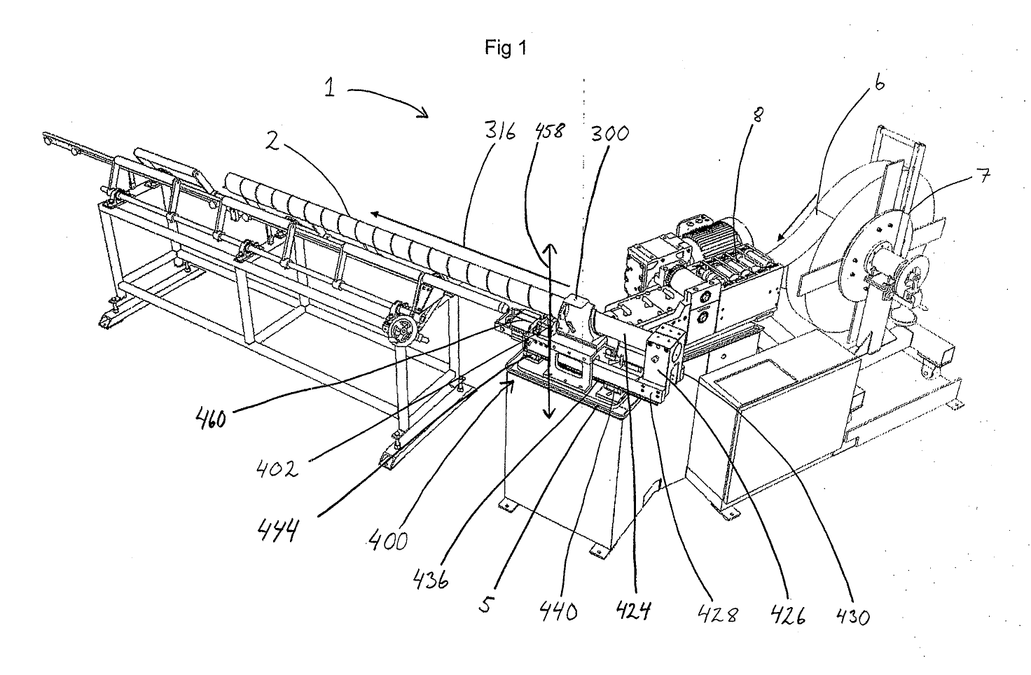

FIG. 1 depicts a tube manufacturing device 1 for manufacture of spirally formed tube 2. The tube manufacturing device 1 comprises a forming head 300 and a cutting unit 400. A continuous metal strip 6 is fed, from a feed device 7 comprising the strip 6, to the tube manufacturing device 1 via a shaping mill 8 provided with powered rollers. When the strip 6 passes through the shaping mill 8, the powered rollers provide the strip 6 with desired correction and/or curvature. From the shaping mill 8, the processed strip 6 is led towards the forming head 300 disposed on the tube manufacturing device 1. The shaping mill 8 is preferably situated in the immediate vicinity of the tube manufacturing device 1 in such a way that they are connected to one another. The strip 6 is shaped by the forming head 300 to constitute a tube 2 which leaves the forming head 300 in a feed direction 316.

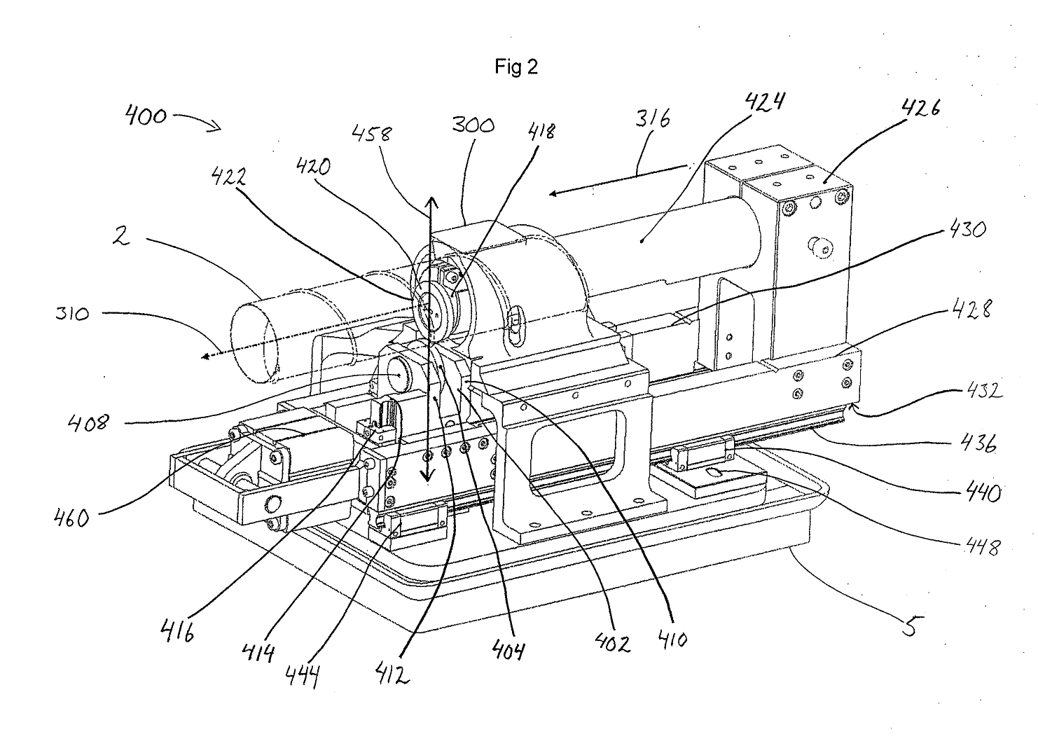

FIG. 2 depicts a tube manufacturing device 1 according to FIG. 1 for manufacture of spirally formed tube 2. The tube manufacturing device 1 comprises the forming head 300 and the cutting unit 400. The cutting unit 400 comprises a knife holder 402 adapted to being movable towards the tube 2 to cutting position before cutting of the tube takes place. This direction is called the cutting direction 458.

The continuous metal strip 6 running from a feed device 7 via the shaping mill 8 and the latter's powered rollers is led towards the forming head 300 disposed on the tube manufacturing device 1. As mentioned above, the shaping mill 8 is preferably situated in the immediate vicinity of the tube manufacturing device 1 in such a way that they are connected to one another. Their being connected to one another thus makes it possible for the strip 6 to be led into the tube manufacturing device 1 in an unvarying manner. This means that the manufacturing process need not be interrupted for adjustment of the way the strip 6 enters the tube manufacturing device 1. The forming head 300 is adapted to receiving the strip 6 in an inlet 302 to the forming head 300 (features pertaining to the forming head are not depicted in the drawing). In a cross-section through the forming head 300, the inlet is U-shaped and has a bottom. The U shape comprises a first leg and a second leg each disposed on its respective side of the bottom. Each leg has a surface which faces towards a centreline 310 extending through the forming head 300. The surface of the first leg is called the first slide surface. The surface of the second leg is called the second slide surface. The strip 6 fed in via said inlet to the forming head 300 is led in a looplike movement along the slide surfaces. After the strip 6 has undergone approximately one revolution inside the forming head 300, one edge region of the strip 6 meets the other edge region. A pressing element situated at the junction between the edge regions continuously seams the respective edge regions together (not depicted in the drawing), resulting in a spiral shape which constitutes the tube 2. The forming of a tube 2 thus takes place in the forming head 300. The finished tube 2 leaves the forming head 300 in a feed direction 316 which is parallel with the centreline 310 of the forming head 300.

When the tube 2 has been made to a desired length, it is cut. This is done by the cutting unit 400 disposed in the tube manufacturing device 1. The cutting unit 400 is so disposed in the tube manufacturing device 1 as to be capable of being regulated independently of the forming head 300 which is also disposed in the tube manufacturing device 1. This is described in more detail further on in the text with regard to regulation of cutting angle. As above, the cutting unit 400 comprises a knife holder 402.

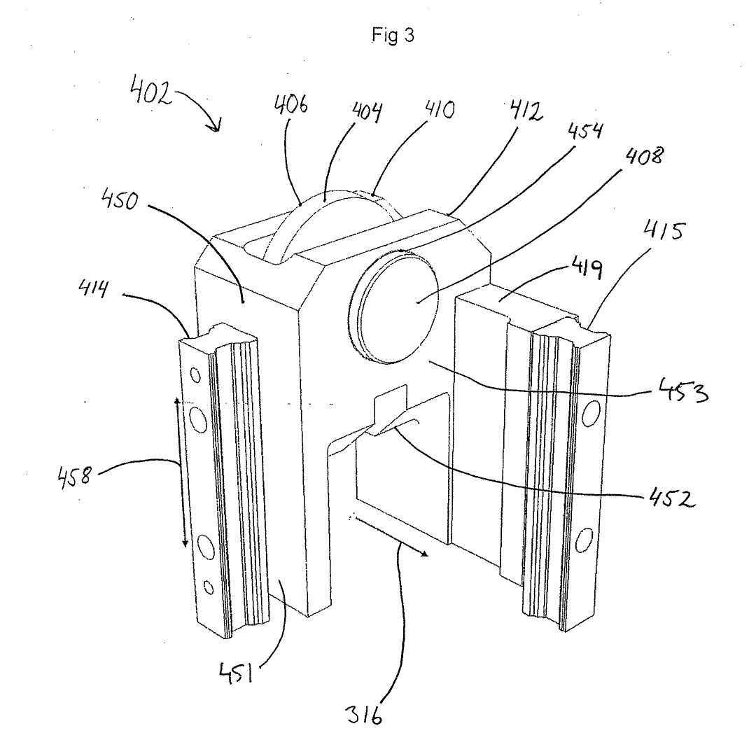

FIG. 3 shows the knife holder 402 situated, in the feed direction 316, after the forming head 300. The knife holder 402 comprises a knife element 404. This knife element 404 is circular and provided with a cutting edge 406 along its periphery. The knife element 404 is fitted in the knife holder 402 via a shaft 408. The shaft 408 is supported by the knife holder 402 via at least one shaft-bearing part 410 and 412, each preferably in the form of a recess (shaft-bearing part) in which the shaft 408 is fitted. The knife holder 402 is adapted to being movable in the cutting unit 400.

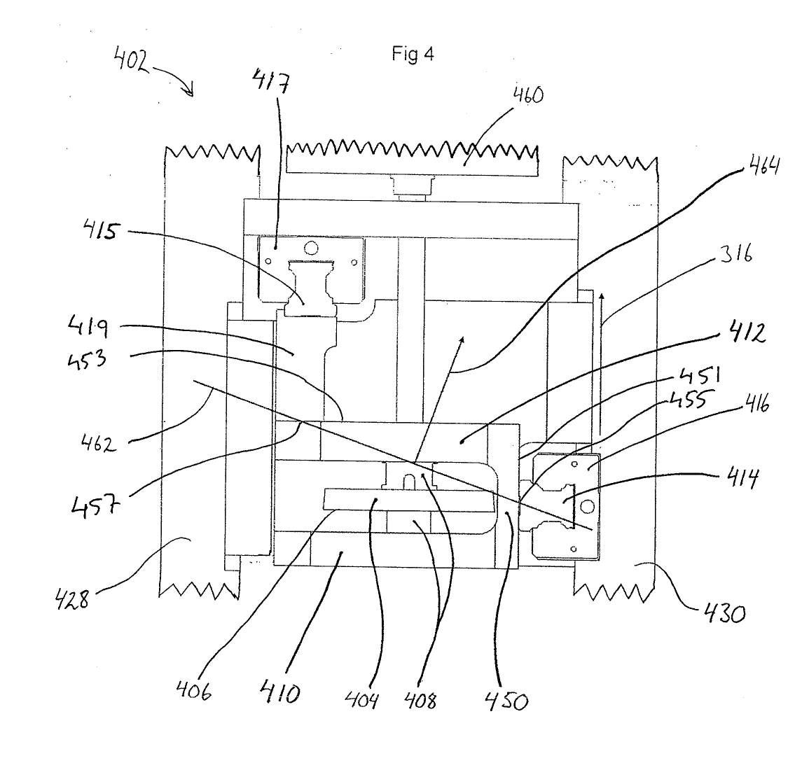

With reference now also to FIG. 4, during cutting the knife holder 402 with the knife element 404 has to travel in the cutting direction 458 to a position for cutting the tube 2. This position is such that the knife element 404 with its cutting edge cuts through the surface of the tube 2 in the region which is to be cut. The knife holder 402 travels to the cutting position through so-called linear units disposed between the knife holder 402 at at least two points and the cutting unit 400. Each linear unit takes the form of a first bearing element 414 which in this embodiment comprises a spacing unit 419, and a second bearing element 415 which cooperates with respective fastening elements 416 and 417 disposed on the cutting unit 400. The bearing elements 414, 415 are so disposed on the knife holder 402 that the first bearing element 414 is situated on a first side 451 of the knife holder 402, and the second bearing element 415 is situated on a second side 453 of the knife holder 402. An imaginary plane 462 which passes through midpoints 455, 457 on the respective bearing elements contact surface with the knife holder 402 and runs in the cutting direction 458 has a perpendicular direction 464. Owing to the bearing elements 414, 415 being situated relative to one another on the respective sides 451, 453 of the knife holder 402, the perpendicular direction 464 is not parallel with the tube's longitudinal direction and the feed direction 316. As discussed above, this means that the bearing elements 414, 415 can with minimum wear on the fastening elements 416, 417 absorb the force component which occurs during cutting.

Via linear units, the knife holder 402 with the knife element 404 is thus adapted to being movable in the cutting unit 400. The knife holder 402 is moved to the cutting position by a force acting upon it from below. This force may come from a controlled power unit 460, i.e. a force generating unit (see FIG. 2 and FIG. 4), e.g. a hydraulic compact cylinder, or a fitted toggle joint which is acted upon pneumatically, hydraulically or mechanically.

A back-up 418 is disposed opposite to the knife holder 402 (see FIG. 2). The back-up 418 cooperates with the knife holder 402 and the latter's knife element 404 in such a way that an anvil for the knife element 404 is provided by the back-up. The back-up takes the form of a second knife element 420 with a second cutting edge 422. The back-up 418 is fitted on one end of a bearing arm 424. The other end of the bearing arm 424 is fitted in a body 426 which is firmly connected to the cutting unit 400. In the feed direction 316, the body 426 is situated before the forming head 300. The bearing arm 424 extends with the back-up 418 through the forming head 300 parallel with the centreline 310. During cutting, the knife element 404 on the knife holder 402 and the second knife element 420 on the back-up 418 are so disposed relative to one another that their respective cutting edges 406 and 422 overlap one another. The overlap may be likened to how the blades of a pair of scissors relate to one another when cutting through, for example, a sheet of paper.

The cutting unit 400 comprises a first beam element 428 and a second beam element 430 which are parallel to one another. Between the beam elements 428 and 430, the body 426 is disposed at one end of the beam elements 428 and 430, where it is connected firmly to them by connecting elements. Between the beam elements 428 and 430, a short distance in from the other end, the knife holder 402 is connected movably to them via said bearing elements 414, 415 and fastening elements 416, 417.

A second linear unit is disposed on the respective underside 432 and 434 of each beam element 428 and 430. This second linear unit takes the form of respective first and second rails 436 and 438 connected to the respective first and second undersides 432 and 434 by connecting elements (the drawing does not show 438 and 434). At the end of the beam elements 428 and 430 comprising the body 426, the respective rails 436 and 438 are disposed in respective first and second rear runners 440 and 442 (the drawing does not show 442). In the region of the knife holder 402, each rail 436 and 438 is disposed in respective first and second forward runners 444 and 446 (the drawing does not show 446). The rear runners 440 and 442 are disposed parallel to one another on the cutting unit 400. A setting element 448 is adapted to being movable on a worktable 5 for the cutting unit 400. The forward runners 444 and 446 are disposed parallel to one another and adapted to being rotatable with the worktable 5. The setting element 448 is so disposed that the rear portion of the cutting unit 400 can be regulated sideways on the worktable 5 about a respective axis between the worktable 5 and the respective forward runners 444 and 446. The rear portion of the cutting unit 400 can be regulated to set a correct cutting angle for the knife element 404 relative to the feed direction 316 of the tube 2 leaving the forming head 300. Setting an incorrect cutting angle will result, during the cutting operation, in the section cut through the tube 2 by the knife element 404 not ending where it began, causing the formation between two pipe sections of an edge or portion which will continue to hold the pipes together. This edge has then to be cut away or broken off for the tube 2 to be fully cut.

The knife holder 402 (see FIGS. 3 and 4) as above is configured to be disposed in said cutting unit 400 in a tube manufacturing device 1. The knife holder 402 comprises first and second shaft-bearing parts 410 and 412 between which a wall element 450 is disposed. The shaft-bearing parts 410 and 412 and the wall element 450 constitute together a shape similar to a U-beam. A bottom element 452 is disposed against one end of the shaft-bearing parts 410 and 412. In a region on the other end of the respective shaft-bearing parts 410 and 412, opposite to the end adjacent to the bottom element, a shaft 408 is disposed between the shaft-bearing parts 410 and 412. The shaft 408 is fitted in respective recesses 454 (the drawing shows only one recess) provided in the respective shaft-bearing parts 410 and 412. The shaft 408 is fitted in each recess 454 with a bearing 456 (not depicted in the drawing). This makes it possible for the shaft 408 to rotate with low friction in the respective recesses 454. The shaft 408 supports the knife element 404. The knife element 404 is disposed centrally on the shaft with a centre of gravity situated at the centreline of the shaft 408. The weight of the knife element 404 and a force against that weight are distributed evenly on the respective shaft-bearing parts 410 and 412 which support the shaft 408 and the knife element 404.

Motion of the knife element 404 in the cutting direction 458 towards or away from the position for cutting a tube 2 is imparted by a pushing or pulling force acting upon the bottom element 452. Pushing moves the knife holder 402 towards cutting position. Pulling moves the knife holder 402 away from cutting position.

The configuration of the bearing elements 414 and fastening elements 416 is with advantage similar to that depicted for the rails and runners belonging to the second linear unit as described above. Each bearing element 414, 415 then takes the form of a rail with a cross-section corresponding to the rail disposed against the respective beam element 428 and 430. Each fastening element 416, 417 then takes the form of a respective runner corresponding to the runner for the respective rail of said beam elements 428 and 430.

According to an embodiment, two bearing elements are disposed on opposite sides of the knife holder 402. Other embodiments may comprise three or more bearing elements provided with corresponding fastening elements. Other configurations with polygonal knife holders, and knife holders in which the knife element is fitted in some other way, are also possible.

According to an embodiment, before cutting of the tube, the knife holder 402 may be moved to its cutting position by a compact cylinder. The compact cylinder pushes in the direction of movement of the knife holder.

According to a further embodiment, before cutting of the tube, the knife holder 402 may be moved to cutting position by a toggle joint. The toggle joint will be controlled by a force-generating element situated, for example, in the feed direction, in front of the knife holder 402 in the tube manufacturing device 1. The toggle joint will be so disposed that when the knife holder 402 is in its cutting position, the toggle joint will have assumed a position such that in the direction of movement of the knife holder 402 the toggle joint is rigid.

The invention is not limited to the embodiment depicted but may be varied and modified within the scope of the claims set out below.

### REFERENCE NOTATIONS IN THE DRAWINGS

1. tube manufacturing device

2. tube (spirally formed)

300. forming head

400. tube cutting unit

5. worktable

6. metal strip

7. feed device

8. shaping mill

302. inlet

304. bottom

306. first leg

308. second leg

310. centreline

312. first slide surface

314. second slide surface

316. feed direction

402. knife holder

404. knife element

406. cutting edge

408. shaft

410. first shaft-bearing part

412 second shaft-bearing part

414. first bearing element

415. second bearing element

416. first fastening element

417. second fastening element

418. back-up

419. spacing unit

420. second knife element

422. second cutting edge

424. bearing arm

426. body

428. first beam element

430. second beam element

432. first underside

434. second underside

436. first rail

438. second rail

440. first rear runner

442. second rear runner

444. first forward runner

446. second forward runner

448. setting element

450. wall element

451. first side of knife holder

452. bottom element

453. second side of knife holder

454. recess

455. midpoint on contact surface

456. bearing

457. midpoint on contact surface

458. cutting direction

460. power unit

462. plane

464. perpendicular vector

1. A knife holder (402) for a tube cutting unit (400) adapted to receiving a rotating tube (2) fed out from a tube manufacturing device (1) in a feed direction (316) which is parallel with the longitudinal direction of the tube (2), which rotation takes place about an axis (310) in the longitudinal direction of the tube (2), such that:
the knife holder (402) is so disposed that in the longitudinal direction of the tube (2) it follows the rotating tube (2) and that in a cutting direction (458) it brings a knife element (404) into contact with the tube (2) and thereby creates a cut in the rotating tube (2) at right angles to the longitudinal direction of the tube (2),
the knife holder (402) is provided with at least a first bearing element (414) and a second bearing element (415) configured to engage in respective brackets (416, 417) in the tube cutting unit (400),
wherein the bearing elements (414, 415) are so disposed relative to one another that the perpendicular direction (464) to a plane (462), which plane passes through midpoints (455, 457) on the respective bearing elements contact surface with the knife holder (402) and runs in the cutting direction through the bearing elements (414, 415), and the longitudinal direction of the tube (2) deviate from being parallel.

2. The knife holder according to claim 1, in which the bearing elements (414, 415) are respectively disposed on a first side (451) and a second side (453) of the knife holder (402), which second side is not opposite to the first side.

3. The knife holder according to claim 2, in which said non-opposite sides (451, 453) are at right angles.

4. The knife holder according to claim 3, in which the first side (451) of the knife holder (402) is parallel with the longitudinal direction of the tube (2), and
the second side (453) of the knife holder (402) is at right angles to the longitudinal direction of the tube (2).

5. The knife holder according to claim 4, in which the direction of a perpendicular vector (464) from one side (451) of the knife holder (402) is parallel with the longitudinal direction of the tube (2) and runs in the feed direction.

6. The knife holder according to claim 4, in which the direction of a perpendicular vector (464) from the other side (453) of the knife holder (402) is parallel with the longitudinal direction of the tube (2) and runs against the feed direction.

7. The knife holder according to claim 1, in which at least one of the bearing elements (414, 415) is a linear unit.

8. A tube cutting unit adapted to receiving a rotating tube (2) fed out from a tube manufacturing device (1), comprising a knife holder (402) according to claim 1.

9. The tube cutting unit according to claim 8, further comprising a back-up (418) so disposed in the tube cutting unit (400) that it is situated on the inside of the tube (2) being received and cooperates with the knife element (404) in the knife holder (402) in such a way that an anvil for the knife element (404) is provided by the back-up (418).

10. The tube cutting unit according to claim 9, in which the back-up (418) comprises a second knife element (420).

11. A system comprising a tube manufacturing device (1) and a tube cutting unit (400) according to claim 8.

12. Use of a system according to claim 11.
